(19) United States
(12) Patent Application Publication
(10) Pub. No.: US 2002/0155811 A1
(43) Pub. Date: Oct. 24, 2002

(54) System and method for adapting RF transmissions to mitigate the effects of certain interferences

(76) Inventors: Jerry Prismantas, Federal Way, WA (US); Bruce C. Rothaar, Woodinville, WA (US)

Correspondence Address: Fulbright & Jaworski L.L.P., 2200 Ross Avenue, Suite 2800, Dallas, TX, 75201-2784, US

(21) Appl. No.: 09/837,476

(22) Filed: Apr. 18, 2001

(51) Int. Cl. H04B 1/10

(52) U.S. Cl. 455/63; 455/296

(57) ABSTRACT

An unlicensed RF data delivery system uses interference characterization to adapt the RF transmission to accommodate the interferences. It uses at least one detection system to determine the type of interference present in an RF band. A channel per channel measurement of interference is made, usually in conjunction with a sweep of the total operating spectrum, generating a picture of the interference over the entire frequency spectrum. The system characterizes not only interference levels, but bandwidth of the interference. A profile is generated, the response to that interference profile is one of several methods, such as frequency change; changing modulation to higher or lower levels; changing the channel width; changing the code rate; changing antenna polarity; and using hub diversity. By first characterizing the type of interference, the system response is tailored to maximize the available interference free spectrum.

### TECHNICAL FIELD

This invention relates to interference detection systems and more particularly to a system and method for generating a “picture” of interference in a RF transmission system and for adapting transmission around the determined interference.

### BACKGROUND

Currently, there are several so-called “last mile” and “last foot” transmission systems which are designed to deliver high speed and/or high data capacity from one location to another. Several such systems use RF transmission to replace copper or coaxial wire. Some of these systems are called point to point or point to consecutive point systems and operate in the 28-38 GHz bands. A fundamental characteristic of such existing systems is that their RF transmissions occur in a frequency spectrum protected and regulated by a government. These protected frequency spectrums, or bands, are licensed to certain license holders and only one (or a selected few) may operate in any given physical area. In such situations, rigorous rules apply to anyone holding permits for the usage of those protected bands. Another fundamental characteristic of such protected bands is that all users are licensed to perform the same type of RF transmission.

Because of the licensed nature of such RF bands, only a limited number of companies may provide service within those bands. Thus, in order to widen the choices consumers have, it is desirable for service providers to be able to use unlicensed RF bands to provide high data rate capability to deliver high speed, high capacity data services.

In 1997 the FCC created a wireless arena called Unlicensed National Information Infrastructure (U-NII). System operators are free to operate wireless equipment in three subbands (5.15 to 5.25 GHz, 5.25 to 5.35 GHz and 5.725 to 5.825 GHz) without acquiring a licensed frequency spectrum. Part 15 of the FCC document specifies the conditions for operating wireless equipment in the U-NII frequency band. However, operators are not protected from possible interference from other U-NII operators transmitting in the vicinity or even other systems which utilize the same frequencies.

The IEEE, a standards group, is defining a wireless LAN standard, referred to as IEEE 802.11 for operation in the U-NII band. Equipment that conforms to this standard will operate indoors at the lower frequency sub-band i.e. 5.15 to 5.25 GHz. The ESTI BRAN group in Europe has defined an air interface standard for high-speed wireless LAN equipment that may operate in the U-NII frequency band. Equipment that is compatible with this standard may cause interference with use of these unlicensed bands.

One major problem with the use of such unlicensed bands is that it is very difficult, if not impossible, to control RF interference from other users of the unlicensed band. These other users may be using the selected unlicensed band for uses which are essentially different from that employed to deliver communication services. For example, the 5.25 to 5.35 GHz and 5.725 to 5.825 GHz bands are available for use for outdoor data communication between two points. These uses are typically wideband uses. The same bands are also available for use by narrow band users, such as, by way of example, radar. When the same band is used for wideband, essentially point to point communication, and also used by others for narrow band use such as radar, data communications between sending and receiving antennas will have significant interference from radar pulses, which are broadcast over a wide area in small (narrow) repetitive bursts.

In the current state of the art, there is no discrimination between narrow band or wideband interference. When interference is detected, it is usually based on a signal to noise ratio for any given channel, then the radio switches to a lower level modulation, from either 64 QAM to 16 QAM, or 16 QAM to QPSK, or QPSK to BPSK. This lower modulation shift allows more tolerance for noise and interference.

When operating in a licensed band the interference between transmissions is not only homogeneous, i.e., wideband, it originates from the same type of antenna to accomplish the same type of transmission and is thus controllable. Accordingly, noise (interference from another transmitter on the same frequency or on an interfering frequency) typically will be evenly spread.

In a typical licensed application, the frequency coordination would mathematically predict a certain low level of interference. And if you could not achieve a low level of interference, the license would not be granted. Once the governing body grants the license, then the user is afforded protection. Thus, in a protected band, if a narrow band interferer is detected, the licensed user could call the FCC (or other policing agency) and ask that the agency investigate and rectify the problem. In an unlicensed band, the user is essentially on his/her own and usually no such official remedy is available.

### SUMMARY OF THE INVENTION

The present invention is directed to a system and method which uses at least one detection system to determine the type of interference that is present in an RF band. A channel per channel measurement of interference is preferably made, usually in conjunction with a sweep of the total operating spectrum. This generates a picture of the actual interference over the entire frequency spectrum. The system characterizes not only interference levels, but the bandwidth of the interference and any periodicity associated with the interference. Preferably, once the interference is characterized, a profile is generated, an appropriate response to that interference profile is preferably implemented according to the present invention. For example appropriate interference mitigation may be implemented using frequency hopping; adaptive modulation to higher or lower levels; changing channel width; changing code rate; and/or changing antenna polarity. The system could also use hub antenna diversity. Thus, by first characterizing the type of interference, the system response can be tailored to maximize the available interference free spectrum. In this manner the interference is accommodated by the system.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWING

For a more complete understanding of the present invention, reference is now made to the following descriptions taken in conjunction with the accompanying drawing, in which:

FIG. 1 shows an RF data transmission system using the system and method of the present invention;

FIGS. 2 and 3 are logical branch diagrams showing typical operation;

FIG. 4 shows how time slots can be skipped to avoid interference;

FIGS. 5A AND 5B show shifting channel frequency to avoid interference; and

FIGS. 6A AND 6B show narrowing/splitting the bandwidth of a channel to avoid interference.

### DETAILED DESCRIPTION

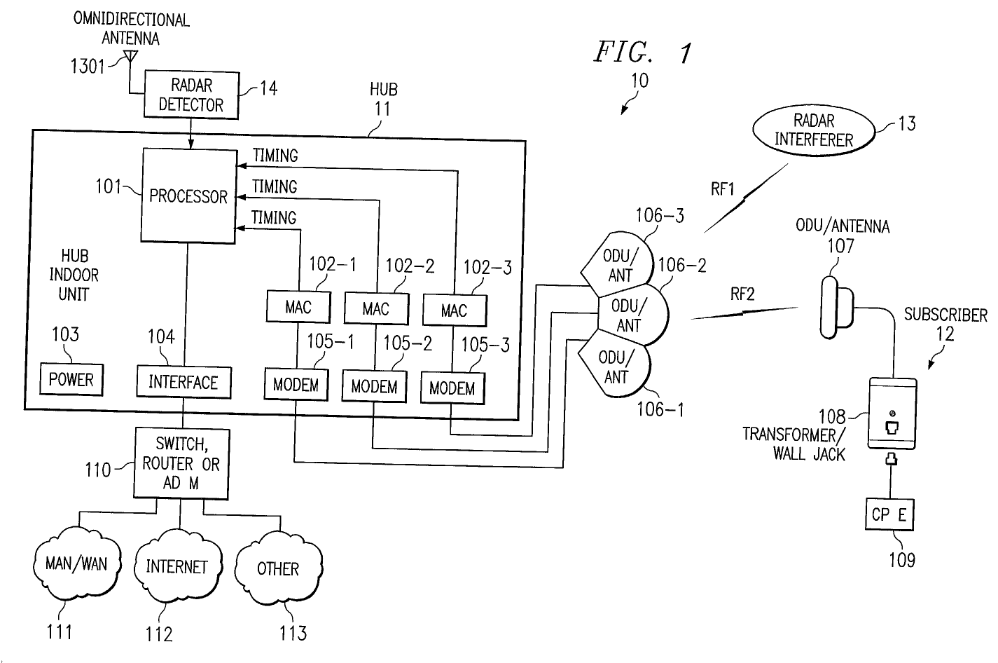

FIG. 1 shows preferred embodiment system 10 having hub 11 (which could be one of many) and subscriber (customer) 12, again one of many. Hub 11 would be connected in a typical installation to other remotely located users (not shown) via one or more networks, such as MAN/WAN 111, Internet 112, or any other network, such as network 113, preferably via switch, router or ADM 110 and interface 104. These networks could be internal to an enterprise or could be connected to public or private networks either directly or via an intermediary network. Power for the hub 11 is provided via power supply 103. Essentially, hub 11 serves to direct communications between subscriber 12 and other users over RF link RF2 between one (or more) hub antennas 106 and subscriber antenna 107. Transmission between these antennas can use one or more modulations, such as, but not limited to, 64 QAM, 16 QAM, QPSK or BPSK. The selected modulation will depend upon many factors and can change dynamically, as will be discussed below. At subscriber 12, transmission to/from customer premises equipment (CPE) 109 flows, by way of example, via wall jack 108. The CPE can be a stand alone computer, a network, telephony equipment or the like.

For our example, we will assume that there is a narrow band interferer, such as radar antenna 13 sending out narrow band RF signals RF1 which impinge on antenna 106-2 thereby causing interference with transmissions RF2 between hub 11 and subscriber 12.

Interference detection, in our example above, then becomes a combination of different detection systems, any one of which can be used alone, but the preference is to use them in combination. A first detection system uses the actual data path between antenna 106-2 and antenna 107. One potential way of collecting interference data would involve the hub 11 taking an on-channel received signal strength indicator (RSSI) reading from a known subscriber unit in the field with the highest nominal power level. Alternatively, the hub will take a “background” measurement, that is, when none of the subscriber units are transmitting.

A second detection path is a narrow band detection system which uses a separate antenna with a separate filter or filters which, in FIG. 1 would be an omni-directional antenna 1301 or the like with radar detector 14. This allows for a sweep of the RF spectrum using a very narrow band filter. The hub antenna 106 can be used to supplement the omni-directional antenna to provide directional data for a narrow band interference source.

A third type of detection would involve performing a Fast Fourier Transform (FFT) analysis on the wideband channels to get narrow band information. The FFT is used to characterize the nature of the interference. By taking the time domain representation of the interfering signal and converting it to the frequency domain via the FFT, the amplitude, bandwidth and periodicity of the interference can be determined. The FFT algorithm can be accomplished in the radar detector 14 or in the modems 105. In one instance, the interfering signal will enter the radar detector via the omnidirectional antenna. The FFT is performed on the signal within the radar detector. The processed signal information is fed to processor 101. In another instance the interfering signal enters the modem via a hub antenna 106. The FFT is performed in the modem and the resulting signal information is sent to the processor 101.

In conjunction with the detection systems the transmitter may be turned off so that the system does not measure its own signal level. In that manner the system can see low level interferers without being masked by its own transmitter. For example an off-channel RSSI measurement is preferably accomplished with a hub antenna performing a rapid off channel measurement (ROCM). For example, the measurement may be made by the hub quickly tuning one of the antennas to an off-channel, taking a measurement, and returning to the on-channel.

For analysis the system, via processor 101, looks at the information provided by the detection systems, preferably signal to noise ratios, both in the frequency and time domains, to find the optimum noise free spectrum in the operating environment. The system also looks at the frequency, bandwidth and time synchronization of the interference. A determination is made as to the type of interference, the timing of the interfering signals, and any reoccurring period or repetitiveness of the interference. The processor determines the interference mitigation technique or techniques to be used based on the nature of the interference and the operational constraints of the network system.

Over time the system will be able to predict when a certain interference event will happen. For example using a knowledge base built over time, the system will be able to recognize that particular types of interference typically have certain shapes and/or durations. The processor can maintain or be preloaded with a set of interference mitigation settings in response to the knowledge base and associated predictions. Preloaded knowledge bases and settings can be tailored to a geographic setting. For example, a particular type of radar interference may be present in a particular region. Once setup and operating for a period of time, the system is trained to use settings for reoccurring or commonly occurring situations as it re-experiences the situation. Thereby the system will learn its environment and operate accordingly.

Based on the gathered and processed data, a determination is preferably made as to the optimum use for the bandwidth, taking into consideration the different interference sources that are present in the spectrum. The actual algorithm can be, by way of example, a software routine that is optimized for any particular site. Based on the analysis, an optimum plan is selected and the system then executes the decisions on how to best utilize the available spectrum. For example, based upon the interference mitigation techniques selected, the modulation of the output of the system via modems 105, under control of a media access control layer (MAC) 102 may be carried out. Preferably the MAC, not only provides information regarding the operation of the modulator, but also provides a mechanism for communicating other changes (e.g. a frequency having a polarity) within the present system by directing data to the appropriate subscriber or other device. Accordingly, based upon the interference mitigation technique selected the channel frequency, modulation, code, rate and/or polarity assigned to a particular user may be altered under control of the MAC. Accordingly, the MAC protocol preferably defines the interfaces and procedures to provide services to the upper protocol layers, particularly the IP protocols.

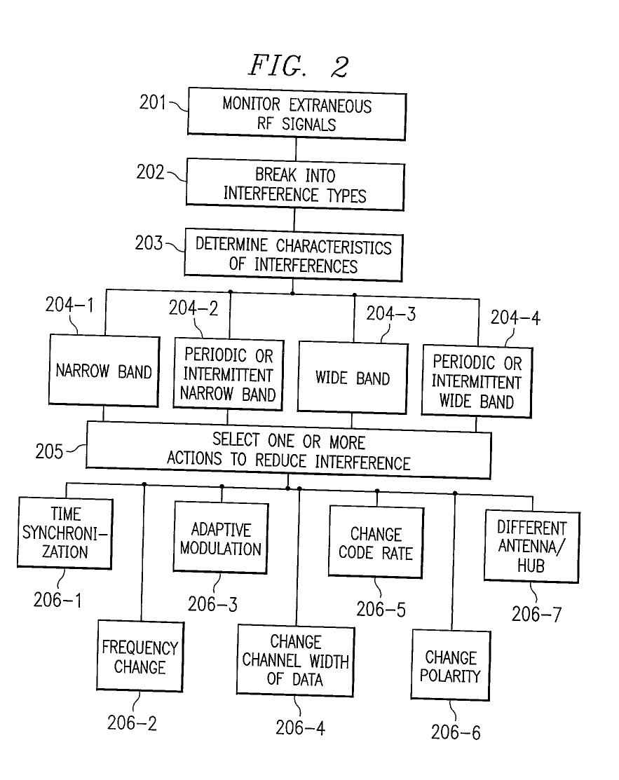

Turning to the logical branch diagram of FIG. 2, as shown in box 201 extraneous RF signals are monitored in accordance with the methods described above. The interference is then broken down into interference types at box 202. Generally, the types of interference affecting the present system are narrow band interference impinging on a particular frequency used by the present system and wideband interference impinging upon several system frequencies. The characteristics of the interference are determined at 203. Interference may be of different types having various characteristics, 204, including narrow band interference, box 204-1, impinging on a particular system channel; periodic or intermittent narrow band interference, occurring at determinable time intervals or for a determinable duration, box 2042; wideband interference, interfering with more than one channel; and periodic or intermittent wideband interference occurring for a determinable time interval, such as a radar pulse, box 204-4.

At box 205 one or more actions are selected to reduce the effects of the interference on RF transmissions. A first decision that could be made to mitigate interference is frequency changing, box 206-2. For example, if a narrow band interference is detected the system could hop from one frequency channel to another, or the system could hop in fractional frequency channel widths to avoid the narrow band interferer. In other words, a frequency operating in the clear can be used to transmit data between the hub and the subscriber. Data concerning the frequency change can be transmitted in the MAC layer from the hub to the subscriber and once the subscriber unit confirms receipt of the MAC data the frequency change can be carried out. If necessary, when the original frequency clears, a similar change back to the original frequency can be carried out. When the communications channel between the hub and subscriber is completely blocked, preventing coordinated parameter changes, the parameter changes will preferably occur in a predetermined sequence. This sequencing information is preferably stored in non-volatile memory at both the hub and subscriber units.

Another method to avoid narrow band interference is to actually change the channel width, box 206-4. This can be done by either changing code rates, data rates, an alpha setting of a nyquist filter, or modulation level. Thereby, the channel is narrowed to avoid a narrow band interferer.

The system can change the modulation type from a more complex to a less complex modulation, or vice versa, depending on the type of interference, box 206-3. For example, the system can go from 64 QAM to 16 QAM and to QPSK, if necessary, and back, depending on what type of wideband interference is detected at any point in time. Additionally, the system could change the code rate of the aggregate spectrum, box 206-5.

The system can switch polarities, box 206-6, from horizontal to vertical or vice versa to avoid either narrow band or wideband interference. This will result in a channel change which must be communicated to the subscriber and acknowledged before the change can take place.

The system can switch from one hub to another or from one antenna to another antenna within the same hub, box 206-7, to avoid either wideband or narrow band interference. This is particularly effective to deal with directional or localized interference. For example a radar, narrowband, interference source may only impinge on a single antenna within the hub. Use of that antenna could be avoided when the radar interference is present. As an alternative example, to deal with a low power broadband interferer located in the line of site between the subscriber and the hub, a different antenna or hub could be used to communicate with the affected subscriber.

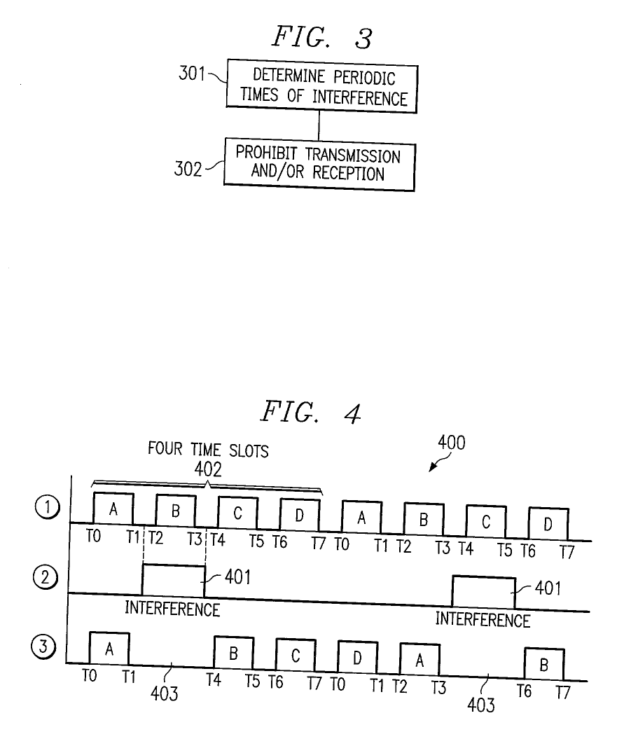

The system can also use time synchronization to transmit in a particular time slot, box 206-1, to avoid interference. As illustrated in FIG. 3, if it is determined there will be interference present at a given time 301, the system can actually not transmit at a given time slot 302. This method of interference mitigation is particularly effective for narrow band interference such as radar, affecting only a few time slots. By pausing transmission for a period of time, the system can avoid the need to resend data or to make extensive use of forward error correction (FEC).

Turning to FIG. 4 a scheme 400 is shown for minimizing the effects of interference 401 in accordance with the mitigation technique of FIG. 3. Of four time slots 402 broadcasting at a given frequency and polarity over a given time frame, one time slot, B is disrupted by interference 401. As shown in the lower portion of FIG. 4, time slot B can be shifted to the next time slot and no transmission made during interfered with time slot 403. If the interference is permanent or continues for a long period of time, a higher modulation or different code rate may be used to accommodate the data within fewer time slots. Alternatively, the overall data rate may be reduced to accommodate the lost time slot.

Another interference mitigation scheme is shown in FIGS. 5A and 5B. In FIG. 5A an interfering signal 501 has rendered channel A, 502, useless. The frequency of narrow band interfering signal 501 is centered on channel A, 502. In FIG. 5B, the channel plan has been adjusted to avoid the interference, while losing only a small fraction of the total band. To avoid the interference the center frequency of the three channels 502, 503 and 504 can be adjusted on a fractional channel basis. Fractional channel tuning allows the band plan to be adjusted so that a narrow band interferer 501 can be avoided without the loss of a full channel.

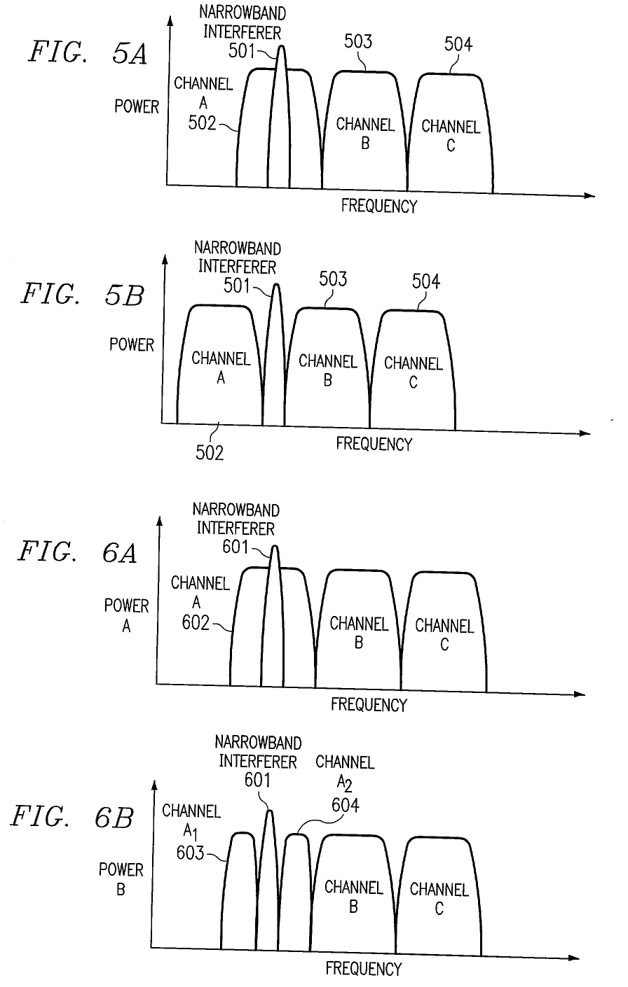

Another type of interference mitigation scheme is shown in FIGS. 6A and 6B. In FIG. 6A interfering signal 601 has rendered channel A, 602, useless. The frequency of narrow band interfering signal 601 is centered on the frequency of channel A, 602. In FIG. 6B, channel A, 602, has been split to avoid the interference. Channel A, 602, can be split into two narrow sub-channels A1, 603, and A2, 604. This split can be accomplished in a number of ways. The modulation level can be increased, the data rate can be decreased, the code rate can be decreased, or on alpha setting of a nyquist channel filter can be decreased. By splitting the channel and adjusting the appropriate modulation parameters the interference 601 can be avoided.

One of the constraints driving which type of decision is chosen will be based on Quality of Service (QoS). If there is a QoS that must be met for any given subscriber, that will constrain the types of interference mitigation decisions that are made. The desired profile for each subscriber can be stored in memory (not shown) associated with the processor 101 and be dynamically changeable, by the subscriber and/or system administrator, if desired. For instance, if a subscriber is guaranteed a given number of megabits per second, then the system may not be able to adapt the channel width because of the constraint on data throughput. Another constraint on which type of decision is made in the interference mitigation is the frequency reuse plan. There are instances where a frequency choice may not be possible because of the frequency reuse plan. The adaptive frequency hopping would not be an option in those cases. A data transmission system must generally provide for a workable frequency reuse plan in the downstream and upstream direction for an established cell radius. Reuse plans must be adapted to meet specific goals.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An RF data transfer system comprising:
means for detecting and characterizing RF interference with said data transfer; and
means for adjusting the RF transmission to avoid said interference.

2. The system of claim 1 wherein said adjusting means includes:
means for shifting a sequence of RF time slots to avoid said interference.

3. The system of claim 1 wherein said adjusting means includes:
means for skipping at least one time period in a sequence of time periods to avoid said interference.

4. The system of claim 1 wherein said adjusting means includes:
means for changing modulation rate of said RF data transfer to avoid said interferences.

5. The system of claim 1 wherein said
means for detecting is an antenna separate from the antennas used to effect said RF data transfer.

6. The system of claim 1 wherein said means for characterizing includes:
means for analyzing the RF data transfer for characteristics of interference.

7. A method of reducing RF interference for unlicensed band transmissions, said method comprising the steps of:
calculating characteristics of RF interference within a band of interest to arrive at an interference profile; and
adjusting desired RF transmissions to accommodate said interference profile.

8. The method of claim 7 wherein said calculating step includes the step of:
receiving on an antenna separate from the antenna used for said RF transmission at least a portion of said interference, said portion having energy characteristics different from said desired RF transmissions.

9. The method of claim 7 wherein said desired RF transmissions occur in sequential repetitive time slots and wherein said adjusting step includes the step of:
eliminating at least one of said periodic time slots for the duration of said interference.

10. The method of claim 7 wherein said desired RF transmissions occur in sequential repetitive time slots and wherein said adjusting step includes the step of:
reducing in time at least one of said periodic time slots for the duration of said interference.

11. The method set forth in claim 7 wherein said adjusting step includes the step of:
modifying a modulation scheme of said desired RF transmissions.

12. The method set forth in claim 7 wherein said adjusting step includes the step of:
changing code rate of said desired RF transmissions.

13. The method set forth in claim 7 wherein said adjusting step includes the step of:
using a different antenna for said desired RF transmissions.

14. The method set forth in claim 7 wherein said adjusting step includes the stop using a different hub for said desired RF transmissions.

15. The method set forth in claim 7 wherein said adjusting step includes the step of:
changing frequency of said desired RF transmissions.

16. The method set forth in claim 7 wherein said adjusting step includes the step of:
changing channel width of said desired RF transmissions.

17. The method set forth in claim 7 wherein said adjusting step includes the step of:
changing polarity of said desired RF transmissions.

18. The method set forth in claim 7 wherein said adjusting step includes the step of:
adjusting a time sequence of said desired RF transmissions to accommodate said interference profile.

19. A method for adapting desired RF transmissions to accommodate RF interference said method comprising the steps of:
monitoring an unlicensed RF band for extraneous RF signals;
breaking said extraneous RF signals into interference types;
determining characteristics of said interference, said interface being categorized in at least one of a group of categories consisting of:
narrow band frequency interference;
periodic narrow band interference;
intermittent narrow band interference;
wideband interference;
periodic wideband interference; and
intermittent wideband interference
selecting at least one of a group of categories of action to reduce interference, said group of actions consisting of:
ceasing transmissions on a channel for a time slot conforming to determinable time frames of said periodic interference;
ceasing transmissions on a channel for a time slot conforming to determinable time frames of said intermittent interference;
adapting modulation of said transmissions;
changing code rate of said transmissions;
using a different antenna for said transmissions;
using a different hub for said transmissions;
changing frequency of said transmissions;
changing a channel width of said transmissions;
changing polarity of said transmissions;
adjusting a time sequence of said transmissions to accommodate said periodic interference; and
adjusting a time sequence of said transmissions to accommodate said intermittent interference.

20. The method of claim 19 wherein said monitoring step includes the step of:
receiving on an antenna separate from the antenna used for said RF transmissions at least a portion of said extraneous RF signals, said portion having energy characteristics different from said desired RF transmissions.
